(19) United States
(12) Patent Application Publication
(10) Pub. No.: US 2004/0015572 A1
(43) Pub. Date: Jan. 22, 2004

(54) Gateway and remote server for automatically configuring a device, and method therefor

(75) Inventor: In-pyo Kang, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/448,434

(22) Filed: May 30, 2003

(30) Foreign Application Priority Data
Jun. 18, 2002 (KR) 2002-34134

(51) Int. Cl. G06F 15/177

(52) U.S. Cl. 709/220

(57) ABSTRACT

Provided are a gateway and a remote server for automatically configuring a power line communication device and a method therefore. The gateway includes a network database and automatic setter. The network database stores a plurality of network addresses used for communication of the power line communication device. The automatic setter receives information on an identification of the power line communication device and transmits received information to the network database so that the network database stores received information, and reads one of the plurality of network addresses and allocates the read network address as to the power line communication device so that the power line communication device carries out communication. Accordingly, using a gateway and a remote server, a network can be automatically configured in a power line communication device without the intervention of an installer.

### BACKGROUND OF THE INVENTION

This application claims the priority of Korean Patent Application No. 2002-34134 filed on Jun. 18, 2002 in the Korean Intellectual Property Office, the disclosure of which is incorporated herein in its entirety by reference.

1. Field of the Invention

The present invention relates to the field of automatically configuring a device connected to a network, and more particularly, to a gateway and a remote server for automatically configuring a network of a power line communication (hereinafter referred to as a PLC) device, which communicates with the remote server via a power line using a PLC protocol, and a method therefor.

2. Description of the Related Art

A conventional PLC device has a small memory and a limited network function. Thus, a user has to directly install the conventional PLC device and then configure a network using specific software for configuring the network or a network configuring tool so that the conventional PLC device is connected to and operated with the Internet or the like. Also, the conventional PLC device is required to be set so as to be connected to a gateway via which the PLC device is connected to the Internet. In other words, an installer from a vendor company has to directly visit a house to install one PLC device in the house and the necessary software in the PLC device.

FIG. 1 is a view of a system for configuring a network of a conventional PLC device. Referring to FIG. 1, the system includes a PLC device 110, a network configuring tool 120, a PLC gateway 130, and a PLC network 140. In such a PLC network system, components communicate with each other via a power line using a specific PLC protocol, e.g., LonTalk, CEBus, X10, or the like.

A process of configuring the network of the conventional PLC device will be described with reference to FIG. 1.

First, an installer receives information on identification (ID) of the PLC device 110 and information on the PLC gateway 130 from the PLC device 110 and the PLC gateway 130, respectively, using the network configuring tool 120. Based on received information, a communication method with the PLC network 140 is first set in the network configuring tool 120 and then transmitted to the PLC device 110 and the PLC gateway 130. Thus, the PLC device 110 communicates with the PLC gateway 130 according to the communication method.

Accordingly, in the prior art, an installer has to directly intervene to set a network for networking a PLC device. In other words, the installer has to directly go to a place where the PLC is installed to perform the tasks required in the overall job of setting the PLC device including setting a network, and downloading and updating application programs necessary for operating the PLC device using a corresponding configuring tool. Thus, the overall job is complicated and requires a large amount of cost and time.

### SUMMARY OF THE INVENTION

Accordingly, the present invention provides a gateway through which network addresses are assigned to a newly installed PLC device so as to communicate with a remote server so that the remote server transmits data for configuring a network of the newly installed PLC device to the newly installed PLC device, and a method for automatically configuring the newly installed PLC device in the gateway.

The present invention also provide a remote server, which transmits data necessary for configuring a network of a newly installed PLC device, and a method for automatically configuring the newly installed PLC device in the remote server.

According to an aspect of the present invention, there is provided a gateway for automatically configuring a power line communication device. The gateway includes a network database and an automatic setter. The network database stores a plurality of network addresses used for communication of the power line communication device. The automatic setter receives information on an identification of the power line communication device and transmits received information to the network database so that the network database stores received information, and reads one of the plurality of network addresses and allocates the read network address as to the power line communication device so that the power line communication device carries out communication.

According to another aspect of the present invention, there is provided a computer-readable recording medium on which a program for realizing a method for automatically configuring a power line communication device in a gateway is recorded. In the method, a plurality of network addresses necessary for communication of a power line communication device are stored in a network database. Information on an identification of the power line communication device is received from the power line communication device. Information on the identification of the power line communication device is transmitted to the network database so that the network database stores transmitted information. One of the plurality of network addresses is allocated to the power line communication device.

According to still another aspect of the present invention, there is also provided a remote server for automatically configuring a power line communication device. The remote server includes a database, a device information analyzer, and a device information processor. The database stores information on identifications of a plurality of power line communication devices connected to a network, information on a plurality of gateways, a plurality of application programs executed in the plurality of power line communication devices, and information necessary for configuring networks. The device information analyzer receives data including network addresses of the gateways, network addresses of the power line communication devices, and information on the identifications of the power line communication devices from the gateways via the network, and detects and outputs information on the identifications of the power line communication devices. The device information processor receives information on the identifications of the power line communication devices from the device information analyzer, if information on the identifications of the power line communication devices does not include information necessary for configuring the networks, reads information necessary for configuring the networks from the database and transmits read information to the network based on the addresses of the gateways and the addresses of the power line communication devices.

According to yet another aspect of the present invention, there is provided a method for automatically configuring a power line communication device in a remote server. Information on identifications of a plurality of power line communication devices connected to a network, information on a plurality of gateways, a plurality of application programs executed in the plurality of power line communication devices, and information necessary for configuring networks are stored in a database. Data including network addresses of the gateways, network addresses of the power line communication devices, and information on the identifications of the power line communication devices are received from the gateways via the network. Information on the identifications of the power line communication devices are detected and output. If information on the identifications of the power line communication devices does not include information necessary for configuring the networks, information necessary for configuring the networks is read from the database and read information is transmitted to the network based on the addresses of the gateways and the addresses of the power line communication devices.

### BRIEF DESCRIPTION OF THE DRAWINGS

The above features and advantages of the present invention will become more apparent by describing in detail exemplary embodiments thereof with reference to the attached drawings in which:

FIG. 1 is a view of a system for configuring a network of a conventional PLC device;

FIG. 2 is a block diagram explaining a system for automatically configuring a PLC device according to the present invention;

FIG. 3 is a block diagram explaining an embodiment of a gateway for automatically configuring a PLC device according to the present invention;

FIG. 4 is a block diagram explaining an embodiment of a remote server for automatically configuring a PLC device according to the present invention; and

FIG. 5 is a flowchart explaining a method for automatically configuring a PLC device in a PLC gateway 220 and a remote server 240.

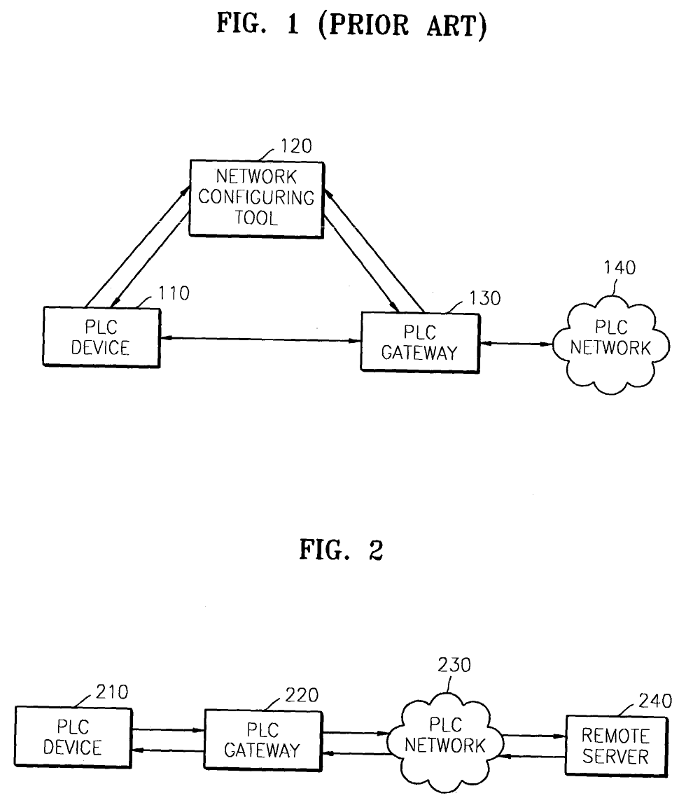

### DETAILED DESCRIPTION OF THE INVENTION

Hereinafter, preferred embodiments of the present invention will be described in detail with reference to the attached drawings.

FIG. 2 is a block diagram explaining a system for automatically configuring a PLC device according to the present invention. The system includes a PLC device 210, a PLC gateway 220, a PLC network 230, and a remote server 240.

The PLC device 210 communicates with the remote server via a power line using a PLC protocol. When the PLC device 210 is first connected to the PLC gateway 220, the PLC device 210 does not contain information on network configuration. Thus, the PLC device 210 cannot carry out communication. However, when the PLC device 210 is plugged into the power line, the PLC device 210 transmits information on ID thereof, e.g., a model number thereof, a global unique identifier (GUID), information on hardware, information on the kind and version of software in the PLC device 210, to the PLC gateway 220. The PLC gateway 220, which has received information on the ID of the PLC device 210, transmits a network address necessary for communication to the PLC device 210 so that the PLC device 210 communicates with the remote server 240. Thereafter, the PLC gateway 220 can automatically receive from the remove server 240 information necessary for communication or information such as application programs necessary for operating the PLC device 210.

The PLC gateway 220 assigns a network address to the PLC device 210, which is plugged into the power line to be connected to the PLC gateway 220, transmits information on the PLC device 210 to the remote server 240 to receive necessary information from the remote server 240, and forwards the necessary information to the PLC device 210. The assignment of the network address to the PLC device 210 is automatically carried out based on addressing information stored in a predetermined database in the PLC gateway 220. Thus, whenever new PLC devices are connected to the PLC gateway 220, the PLC gateway 220 automatically assigns network addresses to the PLC devices.

The PLC network 230 connects the PLC gateway 220 to the remote server 240, and thus the PLC gateway 220 communicates with the remote server 240 via the PLC network 230 using a specific PLC protocol.

The remote server 240 receives information on the PLC device 210 from the PLC gateway 220 and transmits necessary software or information on configuration to the PLC gateway 220. The remote server 240 includes a database which stores data on various application programs necessary for operating the PLC device 210, configuration, or the like. Thus, the remote server 240 analyses information on the PLC device 210 received from the PLC gateway 220, downloads the application programs, configures the PLC device 210, and so forth.

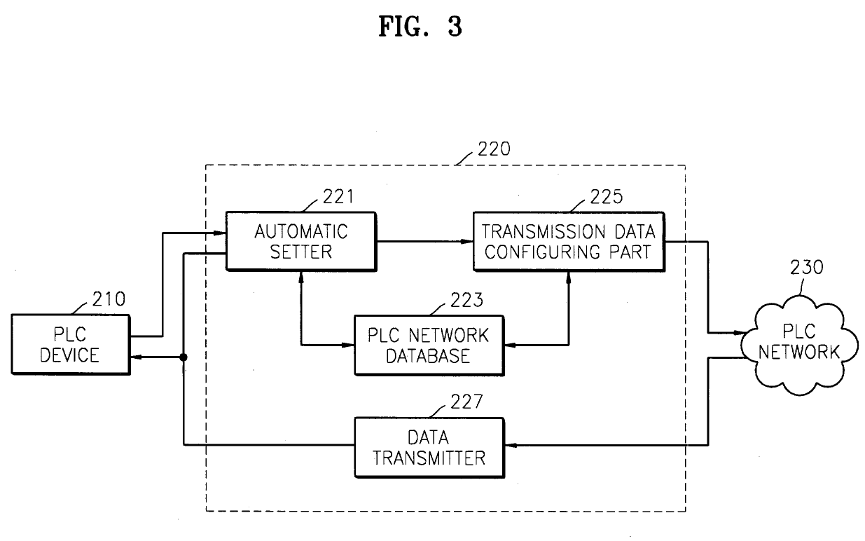

FIG. 3 is a block diagram explaining an embodiment of the PLC gateway 220 for automatically configuring a PLC device according to the present invention. The PLC gateway 220 includes an automatic setter 221, a PLC network database 223, a transmission data configuring part 225, and a data transmitter 227.

The automatic setter 221 receives information on an ID of the PLC device 210, compares information on the ID of the PLC device 210 with information on a plurality of PLC devices stored in the PLC network database 223, and determines whether the PLC device 210 is a new PLC device, based on the compared result. If it is determined that the PLC device 210 is a new PLC device, the automatic setter 221 transmits information on the ID of the PLC device 210 to the PLC network database 223. Thereafter, the automatic setter 221 reads one of a plurality of network addresses to be assigned to newly connected PLC devices from the PLC network database 223 and transmits the received network address to the PLC device 210. A predetermined space of the PLC network database 223 stores information on the ID of the PLC device 210 and on the network address transmitted to the PLC device 210. Since the PLC device 210 is granted the network address, the PLC device 210 can communicate with the remote server 240.

The PLC network database 223 stores network addresses to be assigned to the PLC device 210, information on the ID of the PLC device 210 received from the automatic setter 221, information on the PLC gateway 220, and information on the position of the PLC gateway 220.

The transmission data configuring part 225 reads from the PLC network database 223 information on an ID and a network address of the PLC device 210 corresponding to information on the ID of the PLC device 210 received from the automatic setter 221 and information on the PLC gateway 220 itself and the position of the PLC gateway 220. If the PLC device 210 is a new PLC device in which a network is not configured, the transmission data configuring part 225 transmits a signal requesting information necessary for configuring a network along with the read information to the remote server 240 via the PLC network 230.

The data transmitter 227 receives data, e.g., information necessary for configuring the network of the PLC device 210, downloaded application programs, updated programs, or the like, from the remote server 240 via the PLC network 230 and transmits data to the network address of the PLC device 210.

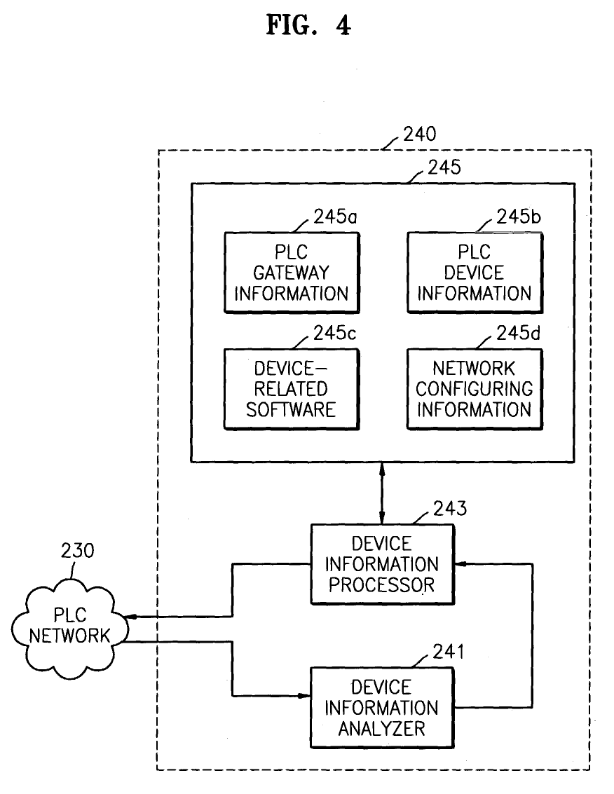

FIG. 4 is a block diagram explaining an embodiment of the remote server 240 for automatically configuring a PLC device according to the present invention. The remote server 240 includes a device information analyser 241, a device information processor 243, and a database 245.

The database 245 stores PLC gateway information 245a, PLC device information 245b, device-related software 245c, and network configuring information 245d. The database 245 stores software necessary for configuring the PLC device 210 and information necessary for configuring the network. Considering information stored in the database 245 in detail, first, the PLC gateway information 245a includes information on the PLC gateway 220, e.g., a network address, an ID, a model number, or the like of the PLC gateway 220. A network group to which the PLC device 210 belongs can be determined using information on the PLC gateway 220.

The PLC device information 245b includes information regarding an ID of the PLC device 210, e.g., a model number, a GUID, hardware, the kind and version of software of the PLC device 210.

The device-related software 245c stores environment files of the PLC device 210 and necessary files. The installer does not need to directly install every file in the PLC device 210 but can download the files stored in the device-related software 245c.

The network configuring information 245d is necessary for operating the PLC device 210 in a power line network. In other words, when a PLC device in which a network is not configured is connected to the PLC gateway 220 via the power line, the PLC device is assigned a network address from the PLC gateway 220, transmits information on an ID thereof to the remote server 240. Then, the remote server 240 transmits the network configuring information 245d to the PLC device so that the PLC device configures a network.

The device information analyser 241 receives data from the PLC gateway 220 via the PLC network 230 and analyses a header of received data to determine the kind of received data.

The device information analyser 241 determines through the analysis of a header field whether the PLC gateway 220 or the PLC device 210 transmits data, and then searches information on the PLC device 210 contained in data. Thereafter, since the device information analyser 241 automatically transmits necessary information to a corresponding device based on the result of the analysis of data, the device information analyser 241 stores information on the position of the corresponding device. Here, information on the position of the corresponding device includes a network address of the PLC gateway 220 and a network address of the PLC device 210. Alternatively, the device information analyser 241 may not store information on the position of the corresponding device but transmit information on the position of the corresponding device together with data to the device information processor 243.

If it is found by the analysis of data that a new PLC device is connected to the PLC gateway 220, the device information analyser 241 searches information requesting information necessary for configuring a network, information on the PLC gateway 220, information on the new PLC device, the kind (a model number or the like) of the new PLC device, and so forth. Next, the device information analyser 241 transmits searched information to the device information processor 243.

The device information processor 243 receives the results of the analysis of data from the device information analyser 241 and accesses the database 245 using information on the PLC gateway 220 and information on the PLC device 210 as a key value. For example, the key value may be obtained by combining the network address of the PLC gateway 220 and the network address of the PLC device 210 in the PLC network 230.

The device information processor 243 reads from the database 245 information corresponding to the key value, e.g., information on software and files, information necessary for configuring a network, or the like corresponding to the key value.

In detail, the device information processor 243 checks whether the PLC device 210 requests information necessary for configuring a network. If it is determined that the PLC device 210 requests information necessary for configuring the network, the device information processor 243 reads the network configuring information 245d from the database 245 and transmits the network configuring information 245d to the PLC device 210 via the PLC network 230.

If the PLC device 210 is not set to communicate with the remote server 240 via the PLC network 230, the device information processor 243 checks whether the PLC device 210 needs new software. Here, necessary software is pre-stored in the device-related software 245c of the database 245 using information on the PLC device 210, e.g., a model number or the like of the PLC device 210, and automatically downloaded when such a PLC device (a device having the same model number as the PLC device 210) is connected.

The device information processor 243 compares information on versions of files in the PLC device 210 with information on versions of files stored in the device-related software 245c of the database 245, checks whether the files are upgraded, and downloads new versions of files.

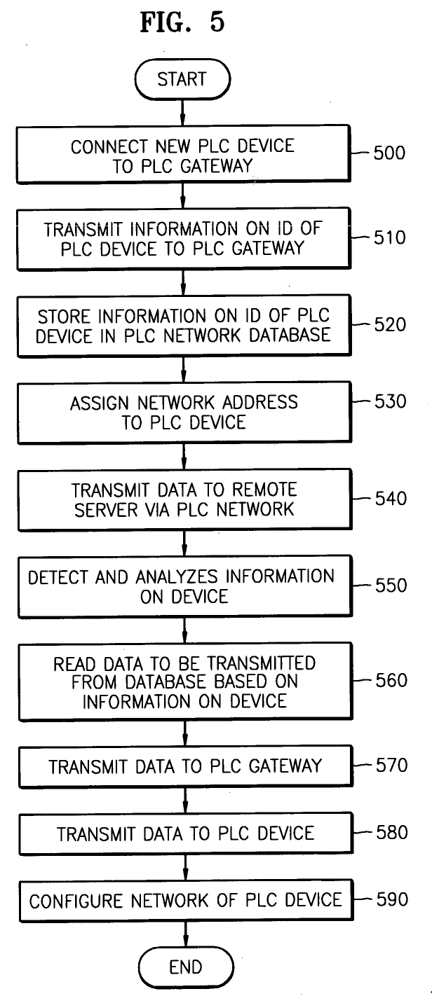

FIG. 5 is flowchart explaining a method for automatically configuring a PLC device in the PLC gateway 220 and the remote server 240 according to the present invention.

Hereinafter, a method for automatically configuring a PLC device in the PLC gateway 220 and the remote server 240 will be described with reference to FIGS. 3 through 5.

First, in step 500, the PLC device 210 is connected to the PLC gateway 220. In step 510, the PLC device 210 transmits information on the ID thereof to the PLC gateway 220. In other words, the PLC device 210 informs the PLC gateway 220 that a new PLC device is connected to the PLC gateway 220 by transmitting information on the ID of the PLC device 210 to the PLC gateway 220.

In step 520, the automatic setter 221 of the PLC gateway 220 receives information on the ID of the PLC device 210 and stores information on the ID of the PLC device 210 in the PLC network database 223.

In step 530, the automatic setter 221 reads one of a plurality of network addresses stored in the PLC network database 223 and allocates the read network address to the PLC device 210.

In step 540, the transmission data configuring part 225 reads from the PLC network database 223 data including a network address of the PLC device 210 corresponding to information on the ID of the PLC device 210, information on the PLC gateway 220 itself, and information on the position of the PLC gateway 220 based on information on the ID of the PLC device 210 received from the automatic setter 221, and transmits read data to the remote server 240 via the PLC network 230.

In step 550, the device information analyser 241 analyses a header of received data and transmits the analysed results, i.e., information on the PLC gateway 220, information on the PLC device 210, the kind of the PLC device 210 (a model number), or the like, to the device information processor 243.

In step 560, the device information processor 243 receives the analysed results of received data from the device information analyser 241, determines information on the PLC gateway 220 and information on the PLC device 210 as a key value, and reads from the database 245 information on software, information on files, information necessary for configuring a network, or the like corresponding to the key value.

In step 570, the device information processor 243 transmits data, which is read from the database 245, to the PLC gateway 220 via the PLC network 230.

In step 580, the data transmitter 227 of the PLC gateway 220 forwards received data to the PLC device 210.

In step 590, the PLC device 210 configures a network based on received data. Also, if received data includes new software or new version of software, the PLC device 210 installs the new software or updates existing software to the new version of software.

As described above, in a gateway and a remote server for automatically configuring a PLC device according to the present invention, and a method for automatically the PLC device in the gateway and the remote server, if a new PLC device is connected to a PLC gateway, the PLC gateway assigns a network address to the PLC device so that the PLC device communicates with the remote server. Thus, the remote server can transmit data necessary for configuring a network of the PLC device to the PLC device. Therefore, an installer does not need to perform the job entailing the tasks required for configuring the PLC device using a device configuring tool. As a result, the overall work is simple, and costs and time required for the overall installation and configuration job can be reduced.

The present invention can be realized among other ways as computer-readable code, or code readable by data processors, incorporated in a computer-readable medium. Computer-readable recording media include all kinds of recording apparatuses which store computer-readable data. Computer-readable recording media include ROMs, RAMs, CD-ROMs, magnetic tapes, floppy discs, optical data storing apparatus, control cards, circuit boards, firmware, hardware and so forth. Computer-readable recording media also include apparatuses realized in the form of a carrier wave (e.g., transmission via the Internet). Furthermore, computer-readable recording media can store data distributed in computers connected to each other via a network as code that the computers can read according to a distribution method and execute the code.

What is claimed is:

1. A gateway connected to configure automatically a power line communication device, the gateway comprising:
a network database configured to store a plurality of network addresses for communication of the power line communication device; and
an automatic setter configured to receive information on an identification of the power line communication device and to transmit the received information to the network database enabling the network database to store the received information, to read one of the plurality of network addresses, and to allocate the read network address for the power line communication device to enable the power line communication device to carry out communication.

2. The gateway of claim 1, further comprising a transmission data configuring part connected to read from the network database and to transmit to a network the network address corresponding to information on the identification of the power line communication device, information on the identification of the power line communication device, and a network address, of the gateway with reference to information on the identification of the power line communication device.

3. The gateway of claim 1, further comprising a data transmitter configured to receive via a network information necessary for configuring the power line communication device and to transmit to the power line communication device the received information with the network address of the power line communication device.

4. A remote server connected to automatically configure an installed power line communication device associated with an installing gateway, the remote server comprising:
a database configured to store information on identifications of a plurality of power line communication devices connected to a network, information on a plurality of gateways, a plurality of application programs executed in the plurality of power line communication devices, and information necessary for configuring the network;
a device information analyzer configured to receive via the network from the installing gateway data including a network address of the installing gateway, a network address of the installed power line communication device, and information on the identification of the installed power line communication device, and to detect and to output the information on the identification of the installed power line communication device; and
a device information processor configured to receive the information on the identification of the installed power line communication device from the device information analyzer, to read from the database information necessary to configure the network, if the information on the identification of the installed power line communication device does not include information necessary for configuring the network, and to transmit read information to the network based on the address of the installing gateway and the address of the installed power line communication device.

5. The remote server of claim 4, wherein to determine at least one application program of the plurality of application programs to be transmitted to the installed power line communication device, the device information processor compares a predetermined portion of information on the plurality of power line communication devices stored in the database with a corresponding portion of information on the identification of the installed power line communication device, and reads from the database and transmits to the network the at least one application program.

6. The remote server of claim 4, wherein the device information processor stores in the database information on the identification of the installed power line communication device.

7. The remote server of claim 5, wherein the predetermined portion of information on the plurality of power line communication devices is power line communication device model number information.

8. The remote server of claim 6, wherein information on the identifications of the plurality of power line communication devices stored in the database comprises model number information, identification number information, and application program information.

9. The remote server of claim 8, wherein the device information processor compares information on a version of an application program included in information on the identification of the installed power line communication device detected from the device information analyzer with information on a version included in information on an application program of one or more of the plurality of power line communication devices stored in the database to determine whether the version of the application program included in information on the identification of the installed power line communication device is to be updated, and reads from the database and transmits to the network at least one application program.

10. A method performed by a gateway to automatically configure a power line communication device, the method comprising:
(a) storing in a network database a plurality of network addresses necessary for communication of a power line communication device;
(b) receiving from the power line communication device information on an identification of the power line communication device;
(c) transmitting information on the identification of the power line communication device to the network database to enable the network database to store the transmitted information; and
(d) allocating one of the plurality of network addresses to the power line communication device.

11. The method of claim 10, further comprising:
(e) reading from the network database and transmitting to the network the network address corresponding to the information on the identification of the power line communication device, the information on the identification of the power line communication device, and a network address of the gateway with reference to the information on the identification of the power line communication device.

12. The method of claim 10, further comprising:
(f) receiving information necessary to configure the power line communication device via the network and to transmit the network address of the power line communication device and information necessary for configuring the power line communication device to the power line communication device.

13. A method performed by a remote server to automatically configure an installed power line communication device, the method comprising:
(a) storing in a database information on identifications of a plurality of power line communication devices connected to a network, information on a plurality of gateways, a plurality of application programs executed in the plurality of power line communication devices, and information necessary for configuring the network;
(b) receiving from an installing gateway via the network data including a network address of the installing gateway, a network address of the installed power line communication device, and information on the identification of the installed power line communication device;
(c) detecting and outputting information on the identification of the installed power line communication device; and
(d) if information on the identification of the installed power line communication device does not include information necessary to configure the network, reading information necessary to configure the network from the database and transmitting the read information to the network based on the address of the installing gateway and the address of the installed power line communication device.

14. The method of claim 13, further comprising:
(e) comparing a predetermined portion of information on the plurality of power line communication devices stored in the database with a corresponding portion of information on the identification of the installed power line communication device to determine at least one program to be transmitted to the installed power line communication device, reading the at least one program to be transmitted from the database, and transmitting the at least one program to the network.

15. The method of claim 13, wherein step (c) comprises:
(c1) storing in the database information on the identification of the installed power line communication device.

16. The method of claim 14, wherein the predetermined portion of information on the plurality of power line communication devices is power line communication device model number information.

17. The method of claim 15, wherein information on the identifications of the plurality of power line communication devices stored in the database comprises model number information, identification number information, and application program information.

18. The method of claim 17, further comprising:
(f) comparing information on a version of an application program included in information on the identification of the installed power line communication device with application program version information included in information on application programs of the plurality of power line communication devices stored in the database to determine whether the version of the application program is to be updated, reading at least one updating application program from the database, and transmitting the at least one updating application program to the network.

19. A computer-readable recording medium incorporating a program to realize a method performed by a gateway of automatically configuring a power line communication device, the method comprising:
(a) storing in a network database a plurality of network addresses necessary for communication of the power line communication device;
(b) receiving from the power line communication device information on an identification of the power line communication device;
(c) transmitting information on the identification of the power line communication device to the network database to enable the network database to store the transmitted information; and
(d) allocating one of the plurality of network addresses to the power line communication device.

20. A computer-readable recording medium incorporating a program to realize a method performed by a remote server to automatically configure an installed power line communication device, the method comprising:
(a) storing information on identifications of a plurality of power line communication devices connected to a network, information on a plurality of gateways, a plurality of application programs executed in the plurality of power line communication devices, and information necessary for configuring networks;
(b) receiving via the network from an installing gateway data including network address of the installing gateway, network address of the installed power line communication device, and information on the identification of the installed power line communication device;
(c) detecting and outputting information on the identification of the installed power line communication device; and
(d) if information on the identification of the installed power line communication device does not include information necessary for configuring the network, reading the information necessary for configuring the network from the database and transmitting to the network read information based on the address of the installing gateway and the address of the installed power line communication device.
